(19) United States
(12) Patent Application Publication
(10) Pub. No.: US 2005/0181270 A1
(43) Pub. Date: Aug. 18, 2005

(54) Proton-exchange membrane fuel cell

(75) Inventor: Mikio Sugiura, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/055,610

(22) Filed: Feb. 11, 2005

(30) Foreign Application Priority Data
Feb. 13, 2004 (JP) 2004-036155

(51) Int. Cl. H01M 4/94; H01M 8/10; H01M 4/96; H01M 4/92

(52) U.S. Cl. 429/44; 429/30

(57) ABSTRACT

A proton-exchange membrane fuel cell includes a polymer electrolyte membrane, a catalyst layer provided on a surface of the polymer electrolyte membrane, a diffusion layer provided on a surface of the catalyst layer, and a membrane-electrode assembly including the polymer electrolyte membrane, the catalyst layer, and the diffusion layer. The catalyst layer includes a fibrous electric conductive material. A content of the fibrous electric conductive material in a region around a first end portion of the catalyst layer close to the diffusion layer in thickness direction is greater than a content of the fibrous electric conductive material in a region around a second end portion of the catalyst layer close to the polymer electrolyte membrane.

### CROSS REFERENCE TO RELATED APPLICATIONS

This application is based on and claims priority under 35 U.S.C. §119 with respect to Japanese Patent Application No. 2004-036155 filed on Feb. 13, 2004, the entire contents of which are incorporated herein by reference.

### FIELD OF THE INVENTION

The present invention relates to a proton-exchange membrane fuel cell. More particularly, the present invention pertains to a proton-exchange membrane fuel cell which includes a membrane-electrode assembly having a polymer electrolyte membrane, a catalyst layer, and a diffusion layer.

### BACKGROUND

Various types of fuel cells have been developed. Proton-exchange membrane fuel cells have been developed as a power generation system for vehicle and as a stationary power generation system.

According to the proton-exchange membrane fuel cell, electric energy is generated by means of electrochemical reaction between hydrogen and oxygen indicated as the followings.
H₂→2H⁺+2e⁻ (Anode side)
2H⁺+½O₂+2e⁻→H₂O (Cathode side)
H₂+½O₂→H₂O (Total)

The proton-exchange membrane fuel cell generally includes a membrane-electrode assembly (MEA) by adhering a diffusion layer to each catalyst layer of electrodes for the proton-exchange membrane fuel cell made from a polymer electrolyte membrane provided with the catalyst layers having catalyst on both sides thereof. Known fuel cells include separators having gas passages, the separators sandwiching the membrane-electrode assembly. The fuel cell generates the power by supplying hydrogen to an anode and by supplying the air including oxygen to a cathode. The electrochemical reaction is caused at three-phase interface where the catalyst, the electrolyte, and the gas coexist at the fuel cell. In other words, the performance of the fuel cell declines when the three-phase interface amount is declined because reactive portions of the electrochemical reaction is decreased.

The catalyst layer is generally formed by preparing catalyst paste by mixing carbon particles supporting catalyst particles such as platinum on surface thereof and electrolyte including ion conductive polymer into solvent, applying the catalyst paste onto a polymer electrolyte membrane, and drying the applied catalyst paste. The catalyst layer may be formed by applying the catalyst paste onto a fluoroplastic sheet, or the like, drying the catalyst paste, and adhering the dried catalyst onto a polymer electrolyte membrane. Further, the catalyst layer may be formed by applying the catalyst paste onto a diffusion layer which is treated with water repellent finish, drying the catalyst, and adhering the dried catalyst paste onto a polymer electrolyte membrane.

The known catalyst layers include electric conductive material in order to improve electric conductivity as described in JP2003-123769A and JP2002-110178A. The electrically conductive material includes carbon black, graphite, artificial graphite, active carbon, carbon fiber, or the like. The fibrous electrically conductive material particularly includes higher electric conductive effect and reinforcement effect of the catalyst layer because entanglement of fibers ensures continuity of the electric conductive materials.

However, sufficient performance of the cell cannot be obtained only by dispersedly blending the electric conductive material in the catalyst paste. In case the fibrous electric conductive material is included in the catalyst paste, the fiber of the electrically conductive material is stuck into the polymer electrolyte membrane when adhering the diffusion layer for manufacturing the membrane electrode assembly, and this generates cross leakage. The generation of the cross leakage significantly declines durability of the fuel cell.

A need thus exists for a proton exchange membrane fuel cell, which includes a membrane electrode assembly with high durability.

### SUMMARY OF THE INVENTION

In light of the foregoing, the present invention provides a proton-exchange membrane fuel cell, which includes a polymer electrolyte membrane, a catalyst layer provided on a surface of the polymer electrolyte membrane, a diffusion layer provided on a surface of the catalyst layer, and a membrane-electrode assembly including the polymer electrolyte membrane, the catalyst layer, and the diffusion layer. The catalyst layer includes a fibrous electric conductive material. A content of the fibrous electric conductive material in a region around a first end portion of the catalyst layer close to the diffusion layer in thickness direction is greater than a content of the fibrous electric conductive material in a region around a second end portion of the catalyst layer close to the polymer electrolyte membrane.

### BRIEF DESCRIPTION OF THE DRAWINGS

The foregoing and additional features and characteristics of the present invention will become more apparent from the following detailed description considered with reference to the accompanying drawings, wherein:

FIG. 1 is a graph showing particle size distribution of dispersed particles of catalyst paste according to embodiments of the present invention and a comparison example.

FIG. 2 is a cross-sectional photomicrograph of a membrane electrode assembly according to a first embodiment of the present invention.

FIG. 3 shows an overview of a cross section of a membrane electrode assembly according to embodiments of the present invention.

FIG. 4 shows an overview of a cross section of a membrane electrode assembly according to comparison examples.

FIG. 5 is a graph showing a measurement result of leak current of the membrane electrode assemblies according to the embodiment of the present invention and the comparison example.

FIG. 6 is a graph showing a measurement result of performance of fuel cells including membrane-electrode assemblies according to the first and third embodiments of the present invention and first and third comparison examples.

FIG. 7 is a graph showing a measurement result of performance of fuel cells including membrane-electrode assemblies according to a second embodiment of the present invention and second and fourth comparison examples.

### DETAILED DESCRIPTION

Embodiments of the present invention will be explained with reference to illustrations of drawing figures as follows.

A proton exchange membrane fuel cell includes a membrane-electrode assembly (MEA) including a polymer electrolyte membrane, a catalyst layer formed on surfaces of the polymer electrolyte membrane, and a diffusion layer provided on a surface of the catalyst layer. The catalyst layer includes fibrous electric conductive material. A content of the electric conductive material at a region around a first end portion close to the diffusion layer in the thickness direction of the catalyst layer is determined to be greater than a content of the electric conductive material content at a region around a second end portion close to the polymer electrolyte membrane of the catalyst layer.

The proton exchange membrane fuel cell according to the embodiment of the present invention includes the catalyst layer including fibrous electric conductive material. The electric conductivity of the catalyst layer is improved by means of the fibrous electric conducive material included in the catalyst layer. Further, because the fibrous electric conductive material are entangled each other in the catalyst layer, the entangled electric conductive material reinforces the catalyst layer per se.

With the proton exchange membrane fuel cell according to the embodiment of the present invention, the electric conductive material content at the first end portion of the catalyst layer close to the diffusion layer is determined to be greater than the electric conductive material content at the second end portion of the catalyst layer close to the polymer electrolyte membrane. In other words, the electric conductive material content of the catalyst layer is different depending on the position in the thickness direction of the catalyst layer. In the thickness direction of the catalyst layer, the electric conductive material content at the polymer electrolyte membrane side is less than the electric conductive material content of the catalyst layer at the diffusion layer side. That is, the catalyst layer at the polymer electrolyte membrane side includes less electric conductive material. Accordingly, with the construction of the MEA of the fuel cell according to the embodiment of the present invention, the polymer electrolyte membrane and the electric conductive material unlikely contact each other. In case the polymer electrolyte membrane and the electric conductive material contact each other, when stress is applied to the MEA for compressing the MEA (and when manufacturing the MEA) in the thickness direction, the electric conductive material having the rigidity is likely stuck into the polymer electrolyte membrane to damage the polymer electrolyte membrane to deteriorate the performance of the polymer electrolyte membrane, and to generate cross leakage. Because the polymer electrolyte membrane and the electrically conductive material unlikely contact each other according to the embodiment of the present invention, the polymer electrolyte membrane is unlikely damaged, and high performance of the fuel cell can be maintained.

It is preferable that the electric conductive material content at the polymer electrolyte membrane side in the thickness direction of the catalyst layer is less. By reducing the electrically conductive material content at the polymer electrolyte membrane side of the catalyst layer, the contact between the electrically conductive material and the polymer electrolyte membrane is further restrained, and thus the decline of the fuel cell performance is restrained. It is preferable that the electrically conductive material is not included at approximate to the second end of the catalyst layer close to the polymer electrolyte membrane. The electrically conductive material and the polymer electrolyte membrane do not contact each other if the electrically conductive material is not included at the second end portion of the catalyst layer close to the polymer electrolyte membrane. Accordingly, the deterioration of the fuel cell performance because of the electrically conductive material sticking into the polymer electrolyte membrane is not generated.

Ratio of the electrically conductive material of the catalyst layer in the thickness direction may be changed either gradually or stepwise.

According to the embodiment of the present invention, materials for the catalyst are not limited as long as the catalyst can facilitate the electrochemical reaction. For example, catalyst metal such as platinum is used as the catalyst.

It is preferable that the catalyst layer includes carbon-supported platinum particles having a median size of 0.1-10 μm and the fibrous electric conductive material having a median size of 0.5-100 μm. The carbon-supported platinum particles serve as catalyst for generating the electrochemical reaction to either oxygen or hydrogen supplied to the catalyst layer. In other words, platinum carried by the carbon particle serves as the catalyst. A carbon-supported platinum includes construction that platinum particles are supported at a surface of the carbon particle. By defining the median size of the carbon-supported platinum as 0.1-10 μm, a three-phase interface where the electrochemical reaction progresses is increased at the fuel cell. In case the median size of the carbon-supported platinum is less than 0.1 μm, the catalyst layer assumes too fine to supply the necessary gas to the three-phase interface. In case the median size of the carbon-supported platinum is greater than 10 μm, the three-phase interface amount is reduced because the electrolyte does not exist in small pores of the carbon-supported platinum particles.

A median size of the fibrous electric conductive material corresponds to a median size when measuring the particle size distribution of the fibrous electric conductive material. A secondary particle which is entangled with the fibers is measured as the median size of the fibrous electric conductive material. By defining the median size of the electric conductive material as 0.5-100 μm, the catalyst layer can ensure high electric conductivity and high rigidity. In case the median size of the electrically conductive material is shorter than 0.5 μm, the effect of the electrically conductive material (i.e., the reduction of the electric resistance of the catalyst layer and the reinforcement effect of the catalyst layer) cannot be sufficiently obtained because the diameter of the electrically conductive material assumes shorter. In case the median size of the electrically conductive material exceeds 100 μm, density variations of the electrically conductive material in the catalyst paste is unlikely sufficiently generated because the diameter of the electrically conductive material is too large. Further, because the thickness of the catalyst layer in general is determined to be 50 μm at the very most, the electrically conductive material is likely to be projected from the catalyst layer. More preferably, the median size of the fibrous electrically conductive material is determined to be 10-20 μm. It is preferable to determine a diameter of the fiber of the fibrous electric conductive material as 100-250 nm, and more preferably as 150-200 nm. The diameter of the fiber of the fibrous electric conductive material corresponds to a diameter of a single fiber per se.

It is preferable that the fibrous electric conductive material carries the catalyst. In other words, the catalyst layer can includes sufficient amount of the catalyst by supporting the catalyst metal by the electrically conductive material. Further, the three-phase interface amount in the catalyst layer is further increased because a three-phase interface for generating the electrochemical reaction is created on the electrically conductive material by means of the catalyst supported by the electrically conductive material. Accordingly, the progress of the electrode reaction is facilitated. This improves the performance of the fuel cell. In case platinum is supported by the fibrous electric conductive material, it is preferable that catalyst weight supported by the fibrous electric conductive material is determined to be equal to or less than 10 wt percent when the weight of the fibrous electric conductive material is determined to be 100 wt percent. More preferably, the catalyst weight is determined to be 2-5 wt percent relative to the fibrous electric conductive material determined as 100 wt percent. In case the catalyst metal amount supported by the electrically conductive material is less than 2 wt percent, the amount of the supported catalyst is too small to effectively function. In case the catalyst metal amount supported by the electrically conductive material exceeds 5 wt percent, utilization of platinum is reduced because of the cohesion among the catalyst metal. Platinum, for example, serves as the catalyst metal.

It is preferable that the fibrous electric conductive material includes carbon fiber. By forming the fibrous electric conductive material with carbon, the foregoing effect can be further improved. The carbon fiber, in this case, includes fibrous carbon including, for example, carbon nanofiber and carbon nanotube. Generally, the carbon nanotube corresponds to tube-shaped carbonaceous material having length of approximately 1.2-1.7 nanometers. The carbon nanotube includes a single wall carbon nanotube, and a multi-wall carbon nanotube. The carbon nanofiber corresponds to a carbon nanotube with a particularly larger diameter. Particularly, the diameter of the carbon nanofiber is determined to be equal to or longer than several nanometers, and the diameter of the lager carbon nanofiber is determined to be approximately 1 micrometer.

It is preferable to determine the ratio of the fibrous electric conductive material in the entire catalyst layer to be 5-40 wt percent relative to the carbon weight in the carbon-supported catalyst. By including the foregoing ratio of the fibrous electric conductive material in the catalyst layer, the effect by compounding the electrically conductive material can be obtained. In case the ratio of the fibrous electric conductive material content in the carbon-supported catalyst is less than 5 wt percent, the effect of including the electrically conductive material in the catalyst layer for improving the electric conductivity and the reinforcement of the catalyst layer cannot be obtained. On the other hand, in case the ratio of the fibrous electric conductive material content in the carbon-supported catalyst exceeds 40 wt percent the thickness of the catalyst layer assumes excessively thick because the amount of the fibrous electric conductive material assumes too much in order to obtain the amount of platinum supported at the catalyst layer irrespective of whether platinum is supported by the surface of the fibrous electric conductive material. The excessive thickness of the catalyst layer may cause inferior for forming catalyst layers, which makes it difficult to manufacture the catalyst layer. Further, because the thickness of the catalyst layer assumes thicker, it assumes difficult to diffuse the gas around the polymer electrolyte membrane, and to move the generated proton to the polymer electrolyte membrane.

According to the embodiment of the present invention, members other than the fibrous electric conductive material in the catalyst layer included in the MEA can be the common with known MEAs for the proton exchange membrane fuel cell.

A membrane such as perfluorosulfonic acid membrane represented by Nafion membrane produced by E.I. Du Pont de Nemours and Company, hydrocarbon system membrane of Hoechst, partial fluorine system membrane, or the like can serve as the polymer electrolyte membrane. It is preferable that the polymer electrolyte membrane has thickness of approximately 25-100 μm.

The catalyst layer is manufactured, firstly, by preparing paste by mixing carbon particles which support platinum particles, fibrous electric conductive material, and electrolyte including ion conductive polymer into solvent or by preparing paste by mixing fibrous electric conductive material which support platinum particles, and electrolyte including ion conductive polymer into solvent, secondly, by applying the paste onto polymer electrolyte membranes, gas diffusion layers, or fluoroplastic sheet, and thirdly, by drying the applied paste. The paste may include polytetrafluoroethylene (PTFE) and polyvinylidene fluoride (PVDF), or the like, serving as bonding agent and water-repellent. It is preferable that the thickness of the catalyst layer is approximately 5-50 μm.

Porous carbon sheet may serve as the diffusion layer. The diffusion layer may assume water repellent by being provided with PTFE layer on surfaces thereof. It is preferable that thickness of the diffusion layer is approximately 100-300 μm.

The manufacturing method for the proton exchange membrane fuel cell is not limited as long as the catalyst layer having different fibrous electric conductive material content in the thickness direction of the catalyst layer can be formed.

For example, in case the catalyst layer is formed by applying the catalyst paste including the catalyst metal (e.g., platinum) to the polymer electrolyte membrane, the catalyst layer can be manufactured by preparing catalyst pastes having different fibrous electric conductive material content, applying the catalyst paste having less ratio of electric conductive material content to the polymer electrolyte membrane to be dried, and thereafter by in turn applying the catalyst paste having greater ratio of the electric conductive material content on the provided catalyst layer having less ratio of electric conductive material content to be dried.

In case the catalyst layer is formed by applying the catalyst paste including the catalyst metal (e.g. platinum) to the member other than the polymer electrolyte membrane such as fluoroplastic sheet, the catalyst layer can be manufactured by preparing catalyst pastes having different fibrous electric conductive material content, by applying the catalyst paste having greater ratio of electric conductive material content to the fluoroplastic sheet to be dried, and by in turn applying the catalyst paste having less ratio of electric conductive material content on the provided catalyst layer having greater ratio of electric conductive material content to be dried.

According to the foregoing manufacturing method, the fibrous electric conductive material content ratio in the catalyst layer is changed stepwise in the thickness direction of the catalyst layer by preparing the plural catalyst pastes having different ratio of fibrous electric conductive material content, and by applying the catalyst pastes on top of one another so that the fibrous electric conductive material content of the catalyst layer is changed stepwise.

According to another manufacturing method, dispersion stability of the catalyst metal (e.g., platinum) and the fibrous electric conductive material in catalyst paste is determined to be different for manufacturing the catalyst layer, and the catalyst layer is manufactured by applying the catalyst paste to either the gas diffusion layer or the fluoroplastic sheet to be dried.

More particularly, a manufacturing method for the proton exchange membrane fuel cell includes a process for preparing paste in which carbon particles are uniformly dispersed by mixing carbon particles which support platinum particles (i.e., carbon-supported platinum), electrolyte including ion conductive polymer, and solvent for solving the electrolyte, a process for preparing catalyst paste by adding fibrous electric conductive material into the paste to be mixed, a process for applying the catalyst paste onto a gas diffusion layer made from porous members, polytetrafluoroethylene (PTFE), or fluoroplastic sheet, or the like, for forming diffusion layers, and a process for holding and drying the applied catalyst paste thereafter.

According to the foregoing manufacturing method of the proton exchange membrane fuel cell, the dispersion stabilities between the carbon-supported platinum and the fibrous electric conductive material in the catalyst paste are different. That is, the dispersion stability of the electrically conductive material is lower than the dispersion stability of the carbon-supported platinum. In the catalyst paste, the fibrous electric conductive material is likely to precipitate. Accordingly, the fibrous electric conductive material in the applied catalyst paste is precipitated, ratio of the fibrous electric conductive material is reduced at a top portion of the applied catalyst paste, and ratio of the fibrous electric conductive material is increased at a bottom portion of the applied catalyst paste. Because the catalyst layer is formed by drying the catalyst paste in the foregoing state, the ratio of the fibrous electric conductive material content of the catalyst layer in the thickness direction is gradually changed.

According to a manufacturing method of the proton exchange membrane fuel cell of the embodiment of the present invention, the paste added with the fibrous electric conductive material is manufactured by strongly dispersing the carbon-supported platinum, the electrolyte, and the solvent with a mixing method for providing mechanical energy to dispersed particles. More particularly, the mixing method is, for example, conducted using devices having media such as a ball mill, a planetary ball mill, a triple roll mill, a jet mill, and homogenizer, or the like.

The mixing conducted after adding the fibrous electric conductive material to the paste is only for providing shear stress to the paste and weaker than the mixing conducted when preparing the paste, and thus the fibrous electric conductive material is gently dispersed in the catalyst paste. The mixing method includes a mixing by means of rotary vane attached at a tip of rotational shaft of a motor, a mixing by means of a stirrer, and a manual mixing method by means of a glass rod.

The porous member for forming the diffusion layer includes members used for forming known diffusion layers for fuel cells, for example, a carbon sheet which is applied with the water repellent.

According to a manufacturing method of the proton exchange membrane fuel cell of the embodiment of the present invention, the prepared catalyst paste is continuously mixed in order to gently disperse the fibrous electric conductive material. By being continuously mixed, the sedimentation of the fibrous electric conductive material before applying the catalyst paste to the porous member or the fluoroplastic sheet can be restrained.

Viscosity of the catalyst paste is not limited as long as the fibrous electric conductive material can precipitate in the catalyst paste. However, it is preferable that the viscosity of the catalyst paste is determined to be equal to or less than 250 cP. Because natural sedimentation is unlikely generated because the sedimentation velocity of the fibrous electric conductive material declines when the viscosity of the catalyst paste exceeds 250 cP, the differences of the ratio of fibrous electric conductive material content of the manufactured catalyst layer is lessen. In other words, the fibrous electric conductive material content of the catalyst layer at the region close to the surface of the polymer electrolyte membrane is increased. In this case, the ratio of the fibrous electric conductive material content at the polymer electrolyte membrane side is determined to be less than the ratio in the region at the diffusion layer side because the sedimentation of the fibrous electric conductive material is generated. According to the embodiment of the present invention, the viscosity of the catalyst paste shows a value measured by an E-type viscometer.

The catalyst paste is applied by known methods.

With the catalyst paste applied to the porous member, PTFE, or the fluoroplastic sheet, the fibrous electric conductive material is precipitated. In other words, by holding the catalyst paste including the fibrous electric conductive material after applying to the porous gas diffusion layer, PTFE, or the fluoroplastic sheet, the fibrous electric conductive material can be precipitated. The sedimentation of the fibrous electric conductive material depends on the viscosity of the catalyst paste and degree of dispersion. Accordingly, the holding time for the applied catalyst paste cannot be determined. As long as the fibrous electric conductive material is precipitated by the time when the applied catalyst paste is dried, it is not necessary to hold the catalyst paste (i.e., the holding time can be zero).

The catalyst paste applied to the porous gas diffusion layer, PTFE, or the fluoroplastic sheet can be dried by known methods, for example, air seasoning at room temperature, and baking at equal to or lower than an allowable temperature limit of the polymer electrolyte membrane.

The catalyst layer formed by drying the catalyst paste applied to the porous gas diffusion layer, PTFE, or the fluoroplastic sheet is adhered to the polymer electrolyte membrane thereafter. It is preferable that the catalyst layer is adhered to the polymer electrolyte membrane by applying pressure approximately 2-10 Mpa to the polymer electrolyte membrane at temperature of 100-160° C. at a top surface of the catalyst (i.e., the surface having less ratio of the fibrous electric conductive material content).

Embodiments of the present invention will be further explained as follows.

A membrane-electrode assembly (MEA) for proton exchange membrane fuel cell is formed according to embodiments of the present invention.

A MEA for proton exchange membrane fuel cell according to a first embodiment of the present invention will be manufactured as the following. Carbon-supported platinum powder containing 55 weight percent of platinum (i.e., a product of Tanaka Kikinzoku Kogyo KK: TEC10E60E), polymer electrolyte solvent including 5 wt percent of resin (i.e., ion exchange resin solvent; a product of E.I. du Pont de Nemours and Company: Nafion SE-5112), and pure water are weighed by the following proportion; which is: 6.3:68.7:25. The carbon-supported platinum, the polymer electrolyte solvent, and the ion-exchange water are mixed well using a sand mill to prepare crude paste. The sand mill including zirconia balls having diameter of φ5 mm is operated for two hours with rotational speed of 15 m/s.

After removing the zirconia balls from the prepared crude paste, carbon fiber having fiber diameter of 150 nm and synthesized by gas phase method (i.e., a product of Showa Denko K.K.: VGCF) is added by proportion of 0.57. In this case, weight ratio between carbon of the carbon-supported platinum powder in the crude paste and the carbon fiber is determined as 100 to 20 (i.e., 100:20). After adding the carbon fiber, a mixture of the crude paste and the carbon fiber is mixed and defoamed for ten minutes by 600 rpm/min of rotation of a planetary portion on its own axis and by 2000 rpm/min of revolution around center of a sun portion using a planetary defoaming mixer (i.e., a product of THINKY corporation). Accordingly, the catalyst paste is prepared.

The prepared catalyst paste is applied to a dimension of 50 cm² using an applicator having a gap of 150 μm on the PTFE, the applied catalyst paste is held for thirty minutes at 80° C. under atmosphere ambient, and the catalyst paste is dried.

The dried catalyst paste is adhered to the polymer electrolyte membrane (i.e., a product of E.I. Du Pont de Nemours and Company: Nafion 112; membrane thickness of 50 μm). The catalyst paste is adhered to the polymer electrolyte membrane by piling the dried catalyst paste to a first surface of the polymer electrolyte membrane, and applying pressure to the piled polymer electrolyte and the PTFE formed with the dried catalyst paste at 10 MPa and 150° C. in the thickness direction. Thereafter, the catalyst layer is peeled from the PTFE, and the dried catalyst paste is adhered by means of pressure to the first surface of the polymer electrolyte membrane. Likewise, dried catalyst is adhered to a second surface of the polymer electrolyte membrane by means of the pressure. The dried catalysts are adhered to the first and second surfaces of the polymer electrolyte membrane simultaneously by means of the pressure. In other words, the pressure is applied from outside the PTFEs at a state that the dried catalyst pastes are positioned at the first and second surfaces of the polymer electrolyte membrane.

Thereafter, carbon sheets treated with the water repellent is adhered to first and second sides of a stack of the dried paste and the polymer electrolyte respectively by means of pressure at 8 MPa and at temperature of 140° C. The carbon sheets treated with the water repellent are manufactured by impregnating the dispersion solvent of carbon black (i.e., a product of Cabot corporation: VULCAN® XC-72R) and water repellent (i.e., a product of DAIKIN INDUSTRIES, LTD.: POLYFLON D1) to carbon sheets (i.e., a product of Toray Industries Inc.: TGP-H-60), and by baking the carbon sheets impregnated with the dispersion solvent for one hour at temperature of 380° C. The carbon sheets treated with the water repellent are adhered to the first and second surfaces of the stack simultaneously by means of the pressure likewise the adhesion of the dried catalyst paste to the polymer electrolyte membrane.

A membrane electrode assembly according to a second embodiment of the present invention is manufactured likewise the MEA of the first embodiment of the present invention, except a point that the catalyst paste is applied to carbon sheets treated with water repellent.

A membrane electrode assembly according to a first comparison example is manufactured likewise the MEA of the first embodiment of the present invention, except a point that the carbon fiber is not added.

In other words, the crude paste prepared according to the first embodiment of the present invention is applied to the PTFE using an applicator having a gap of 150 μm likewise the first embodiment, the applied crude paste is held for thirty minutes at temperature of 80° C. under the atmosphere ambient, and the catalyst paste is dried.

Thereafter, the catalyst paste is adhered to the polymer electrolyte membrane and the carbon sheet treated with the water repellent by means of the pressure to manufacture the MEA likewise the first embodiment of the present invention.

A membrane electrode assembly according to a second comparison example is manufactured likewise the MEA according to the second embodiment of the present invention, except a point that the carbon fiber is not added.

In other words, the crude paste prepared likewise the first embodiment is applied to the carbon sheets treated with water repellent likewise the second embodiment of the present invention using an applicator having a gap of 150 μm, the applied paste is held for thirty minutes at 80° C. under the atmosphere ambient, and the catalyst paste is dried.

Thereafter, the catalyst paste is adhered to the polymer electrolyte membrane likewise the first embodiment of the present invention to manufacture the MEA of the second comparison example.

A membrane electrode assembly according to a third comparison example is manufactured as the following. That is, carbon-supported platinum powder supporting and including 55 weight percent of platinum, polymer electrolyte solvent including 5 wt percent of resin, carbon fiber having fiber diameter of 150 nm, and ion-exchange water are weighed by the following proportion; which is: 6.3:68.7:0.57:25. The carbon-supported platinum, the polymer electrolyte solvent, the carbon fiber, and the ion-exchange water are mixed well using a sand mill to prepare crude paste. The sand mill including zirconia balls having diameter of φ5 mm is operated for two hours with rotational speed of 15 m/s. Catalyst paste according to the third comparison example is prepared in the foregoing manner.

The prepared catalyst paste is applied onto the PTFE likewise the first embodiment using an applicator having a gap of 150 μm, the applied catalyst paste is held for thirty minutes at temperature of 80° C. under the atmosphere ambient, and the catalyst paste is dried.

Thereafter, likewise the first embodiment of the present invention, the dried catalyst paste is adhered to the polymer electrolyte membrane and the carbon sheet treated with the water repellent by means of the pressure to manufacture the MEA according to the third comparison example.

A membrane electrode assembly according to a fourth comparison example is manufactured by applying the catalyst paste prepared according to the third comparison example onto the carbon sheets treated with the water repellent likewise the second embodiment of the present invention using an applicator having a gap of 150 μm, the applied catalyst paste is held for thirty minutes at 80° C. at the atmosphere ambient, and the catalyst paste is dried.

Thereafter, the dried catalyst paste is adhered to the polymer electrolyte membrane likewise the first embodiment of the present invention to manufacture the MEA according to the fourth comparison example.

A membrane electrode assembly according to a third embodiment of the present invention is formed likewise the MEA according to the first embodiment of the present invention, except a point that carbon fibers which support platinum on surfaces thereof are used.

First, crude paste is prepared likewise the first embodiment of the present invention.

The carbon fiber (i.e., a product of Showa Denko K.K.: VGCF) synthesized by the same gas phase method used according to the first embodiment of the present invention, dinitrodiamine platinum nitric acid solution including platinum by 8.5 wt percent, and IPA are dispersedly blended by the following proportion; i.e., 97:35.3:30. The blended carbon fiber, the dinitrodiamine platinum nitric acid solution, and the IPA are dried. Thereafter, hydrogen reduction is applied to the dried mixture by holding for two hours under hydrogen gas ambient at temperature of 160° C. By the foregoing method, carbon fiber supported platinum which supports platinum by 3 weight percent is manufactured. The manufacturing of the carbon fiber supported platinum is confirmed by the thermogravimetric analysis (i.e., platinum is remained).

After removing the zirconia balls from the prepared crude paste, the carbon fiber-supported platinum is added by proportion of 0.57. In this case, weight ratio between carbon of carbon-supported platinum powder in the crude paste and the carbon fiber-supported platinum is determined as 100 to 20 (100:20). After adding the carbon fiber supported platinum, likewise the first embodiment of the present invention, the crude paste added with the carbon fiber-supported platinum is mixed and defoamed by means of the planetary defoaming mixer, likewise the first embodiment of the present invention. Accordingly, catalyst paste according to the third embodiment of the present invention is prepared.

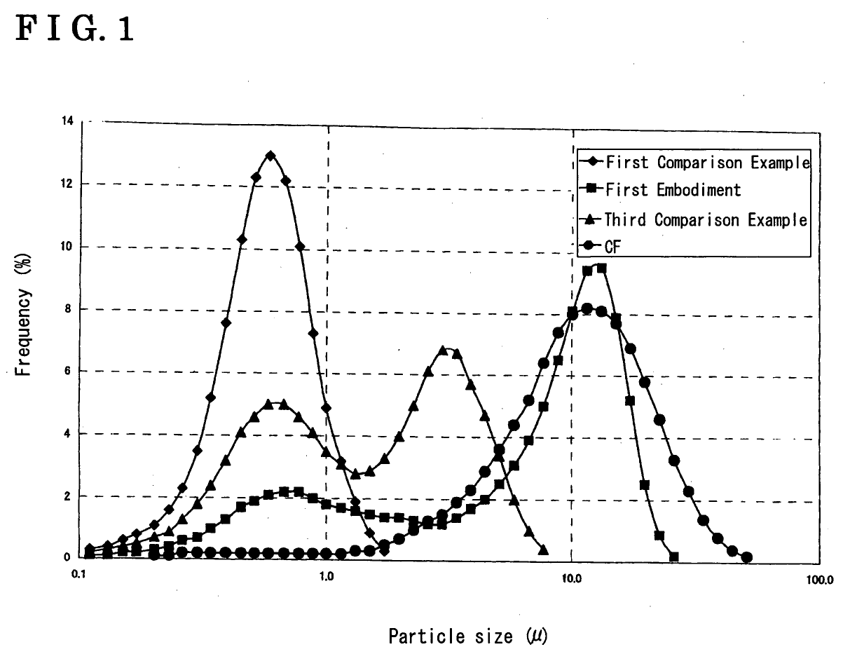

Evaluations of the catalyst pastes are shown as follows. In order to evaluate the catalyst pastes prepared according to embodiments and comparison examples, first, particle size distribution of particles dispersed in the catalyst paste is measured. The particle size distribution of the dispersed particle is measured by particle size distribution analyzer (i.e., a product of HORIBA, Ltd.: LA-500). The particle size of the carbon fiber is also measured. Because the catalyst paste according to the first and second embodiments, the catalyst paste according to the first and second comparison examples, and the catalyst paste according to the third and fourth comparison examples is common respectively, the particle size distributions of the catalyst pastes according to the first embodiment, the first comparison example, and the third comparison example are measured. The measured result of the particle size distribution is shown as FIG. 1.

The particle size distribution of the particles dispersed in the catalyst paste according to the first embodiment of the present invention (i.e., carbon-supported platinum powder and the carbon fiber) is peaked approximately at 0.7 μm and approximately at 12.0 μm.

The particle size distribution of the particles dispersed in the catalyst paste according to the first comparison example (i.e., carbon-supported platinum powder) is peaked approximately at 0.7 μm.

The particle size distribution of the particles dispersed in the catalyst paste according to the third comparison example (i.e., carbon-supported platinum powder and the carbon fiber) is peaked approximately at 0.7 μm and approximately at 3.0 μm.

The particle size distribution of the carbon fiber (i.e., represented as CF in FIG. 1) is peaked approximately at 12.0 μm.

As shown in FIG. 1, considering the peaks of the particle size distribution according to the first embodiment of the present invention, the first comparison example, and the carbon fiber, the peak approximately at 0.7 μm shows the peak by means of the carbon-supported platinum powder, and the peak approximately at 12.0 μm shows the peak by means of the carbon fiber.

As shown in FIG. 1, the third comparison example shows peaks approximately at 0.6 μm and approximately at 8.0 μm. The peak approximately at 0.6 μm shows the peak by means of the carbon-supported platinum powder, and the peak approximately at 8.0 μm shows the peak by means of the carbon fiber. It is considered the deviation of the peak of the third comparison example relative to the first embodiment of the present invention is caused by fining the carbon fiber when mixed by the sand mill.

The viscosity of the catalyst paste according to embodiments and comparison examples was measured as follows. The viscosity of the catalyst paste is measured by an E-type viscometer (i.e., a product of Tokyo Keiki Co., Ltd.: VISCONIC EMD) by rotating No. 34 rotor with 10/min. The measured result is as shown in Table 1.

TABLE 1

| | Viscosity (mPa/s) |
|---|---|
| First embodiment | 143 |
| Third Embodiment | 164 |
| First Comparison Example | 77 |
| Third Comparison Example | 87 |

As shown in Table 1, the catalyst pastes according to the first and third embodiments of the present invention include high viscosity. In other words, the dispersion particles are precipitated with appropriate sedimentation velocity in the catalyst pastes. With the catalyst paste of the third comparison example, the carbon fiber was not precipitated. It is considered that this is caused because the carbon fibers are uniformly dispersed in the catalyst paste.

Evaluations of the catalyst layer are shown as follows.

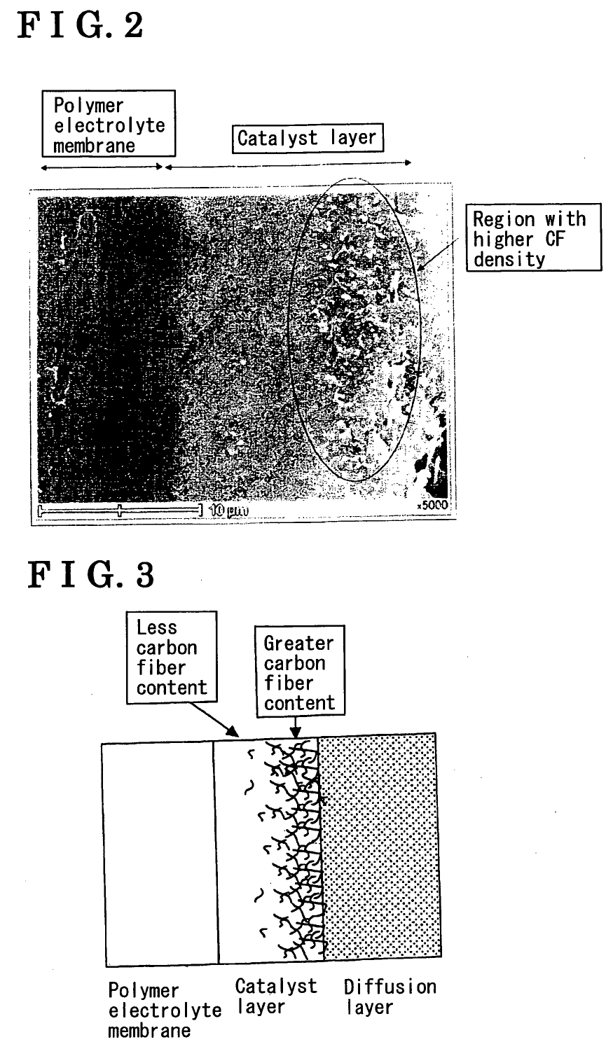

A photomicrograph of a cross-section of the MEA in the thickness direction according to the first embodiment of the present invention is shown in FIG. 2.

As shown in FIG. 2, the carbon fibers are unlikely provided at the polymer electrolyte membrane side of the catalyst layer of the MEA, and the carbon fibers are disproportionately provided at the diffusion layer side of the catalyst layer of the MEA according to the first embodiment of the present invention. Likewise the first embodiment of the present invention, the carbon fibers are disproportionately provided in the catalyst layer of the MEA according to the second and third embodiments of the present invention. Overviews of a cross-section of the MEAs according to each embodiment is shown in FIG. 3.

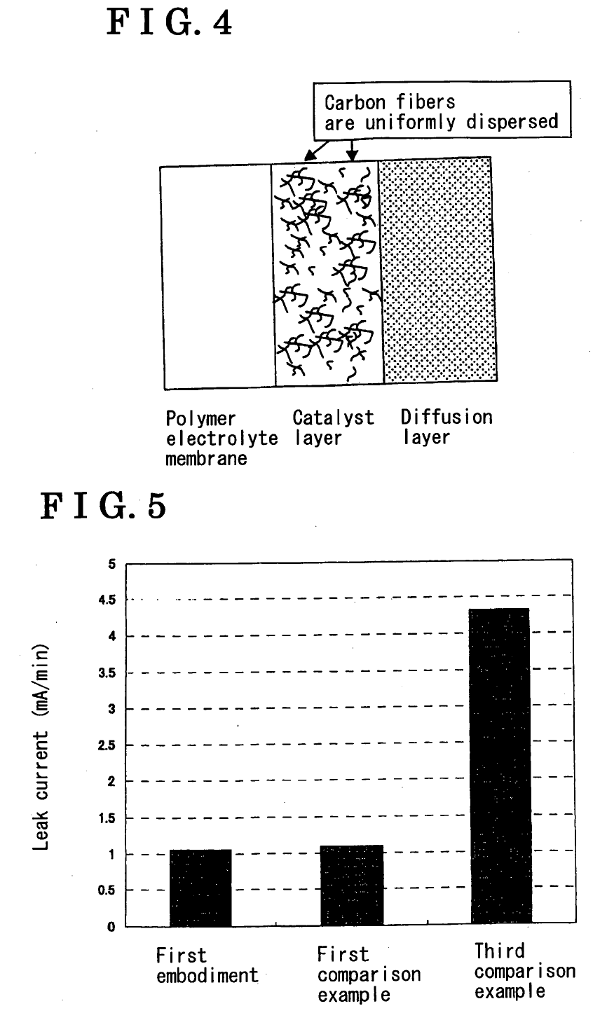

Carbon fibers are uniformly dispersed in the catalyst layer of the MEA according to the third comparison example. The MEAs of each comparison example includes the carbon fibers dispersed approximate to interface with the polymer electrolyte membrane of the catalyst layer. Further, one end of some carbon fibers are even stuck into the polymer electrolyte membrane with the MEA according to the comparison examples. A cross-section of the MEAs according to comparison examples is shown in FIG. 4.

Cell characteristics according to the embodiments and comparison examples are shown as follows. First, the leak currents of the MEAs according to the first embodiment of the present invention and first and third comparison examples were measured.

The leak current is measured by recording an electric current value three minutes after applying electric voltage by 0.2V to the anode and cathodes of the MEA applied with pressure of 60N/cm². The measured result is shown in FIG. 5.

As shown in FIG. 5, the MEA according to the first embodiment of the present invention includes the leak current approximately the same to the first comparison example in which the carbon fiber is not included, even if the carbon fiber is dispersed in the catalyst layer. In other words, the MEA according to the first embodiment of the present invention unlikely generates the cross leakage. To the contrary, large leak current is generated with the MEA according to the third comparison example. The leak current is generated by the carbon fibers provided approximate to the both sides of the polymer electrolyte membrane. The leak current influences the duration (longevity) of the MEA. Accordingly, a fuel cell manufactured from the MEA according to the first embodiment of the present invention enables to maintain the cell characteristics longer than the fuel cell manufactured from the MEA according to the comparison examples.

Further, in order to evaluate the MEA according to embodiments of the present invention and comparison examples, fuel cells are assembled to measure their current-voltage characteristics.

Fuel cells having a single cell is manufactured by providing separators having gas passages at both sides of the MEA according to the first through third embodiments of the present invention and the first through fourth comparison examples.

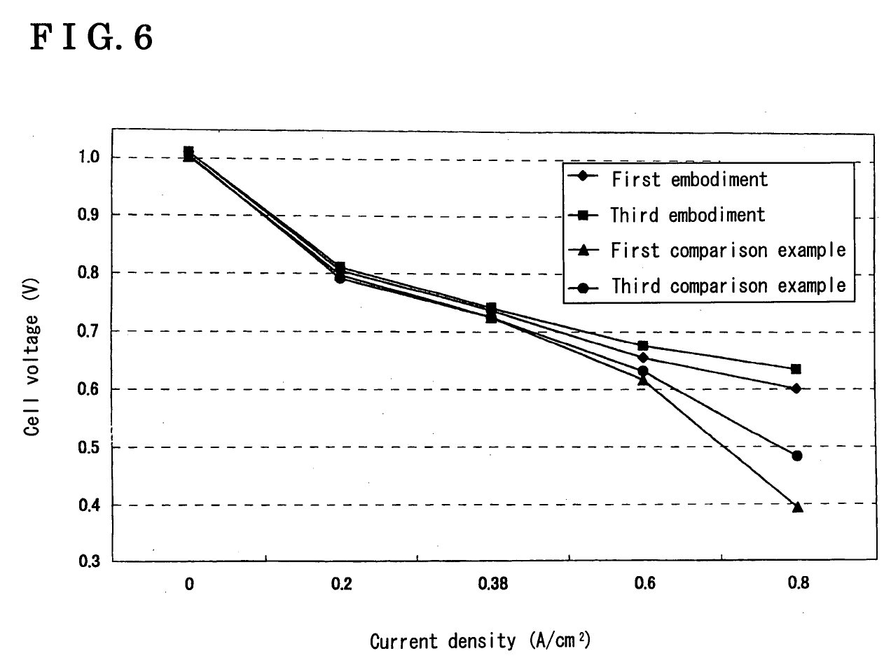

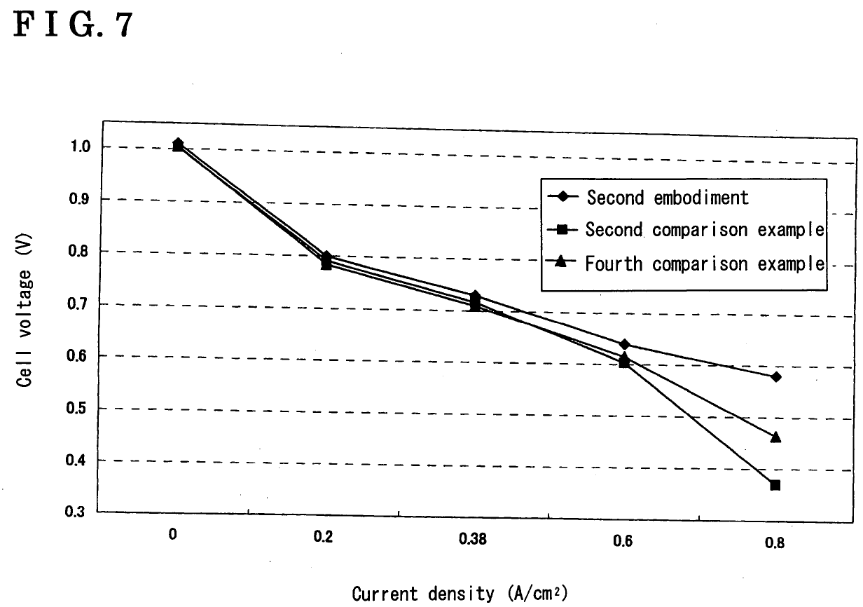

The current-voltage characteristics of the manufactured fuel cells are measured. Hydrogen gas is supplied to the anode and the air is supplied to the cathode. The hydrogen gas and the air supplied to the anode and the cathode respectively are humidified to have a dew point at 60° C. The fuel cells are held at 80° C. when supplied with the gas, and the utilization factor of hydrogen was 90 percent and the utilization factor of the air was 40 percent. The measured results are shown in FIGS. 6-7. FIG. 6 shows the cell characteristics of the first and third embodiments of the present invention, and first and third comparison examples. FIG. 7 shows the cell characteristics of the second embodiment of the present invention, and the second and forth comparison examples.

As shown in FIGS. 6-7, the cell voltage of the fuel cell having the MEAs according to first through third embodiments of the present invention is higher than the cell voltage of the fuel cells having the MEAs according to the comparison examples. The differences of the cell voltage assumes larger as the current density assumes higher. That is, the fuel cells manufactured from the MEAs according to the embodiments of the present invention includes higher cell performance than the fuel cells manufactured from the MEAs according comparison examples.

As shown above, the MEAs according to the embodiments of the present invention can provide fuel cells having high cell performance and longevity because the damages of the polymer electrolyte membrane in the catalyst layers by the carbon fibers is restrained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A proton-exchange membrane fuel cell comprising:
a polymer electrolyte membrane;
a catalyst layer provided, on a surface of the polymer electrolyte membrane;
a diffusion layer provided on a surface of the catalyst layer;
a membrane-electrode assembly including the polymer electrolyte membrane, the catalyst layer, and the diffusion layer; wherein
the catalyst layer includes a fibrous electric conductive material; and
a content of the fibrous electric conductive material in a region around a first end portion of the catalyst layer close to the diffusion layer in thickness direction is greater than a content of the fibrous electric conductive material in a region around a second end portion of the catalyst layer close to the polymer electrolyte membrane.

2. The proton-exchange membrane fuel cell according to claim 1, wherein the catalyst layer does not include the electric conductive material around the second end portion close to the polymer electrolyte membrane.

3. The proton-exchange membrane fuel cell according to claim 1, wherein the fibrous electric conductive material supports a catalyst.

4. The proton-exchange membrane fuel cell according to claim 1, wherein the fibrous electric conductive material has median size of 0.5-100 μm.

5. The proton-exchange membrane fuel cell according to claim 1, wherein the catalyst layer includes carbon-supported catalyst including carbon particles which supports catalyst.

6. The proton-exchange membrane fuel cell according to claim 5, wherein the carbon-supported catalyst has median size of 0.1-10 μm.

7. The proton-exchange membrane fuel cell according to claim 1, wherein the catalyst layer includes a catalyst including platinum.

8. The proton-exchange membrane fuel cell according to claim 1, wherein the fibrous electric conductive material includes carbon fiber.

9. The proton-exchange membrane fuel cell according to claim 1, wherein ratio of the fibrous electric conductive material in the catalyst layer has 5-40 weight percent.

10. The proton-exchange membrane fuel cell according to claim 1, wherein the polymer electrolyte membrane has thickness of 25-100 μm.
